(19) United States
(12) Patent Application Publication
(10) Pub. No.: US 2005/0251663 A1
(43) Pub. Date: Nov. 10, 2005

(54) Computer architechture including implemented and unimplemented registers

(76) Inventor: Alan H. Karp, Palo Alto, CA (US)

Correspondence Address: HEWLETT PACKARD COMPANY, P O BOX 272400, 3404 E. HARMONY ROAD, INTELLECTUAL PROPERTY ADMINISTRATION, FORT COLLINS, CO, 80527-2400, US

(21) Appl. No.: 10/835,178

(22) Filed: Apr. 30, 2004

(51) Int. Cl. G06F 9/30

(52) U.S. Cl. 712/228

(57) ABSTRACT

A computer architecture includes a predetermined number of architected registers. The architected registers include a plurality of implemented registers and a plurality of unimplemented registers.

### TECHNICAL FIELD

The present invention pertains to the field of computer architecture. More particularly, this invention relates to using implemented and unimplemented registers in computer architectures.

### BACKGROUND

One trend in the computer architecture industry today is to increase processor speed. However, processor speed is increasing faster than memory speed, so there is a push to hold data where the processor can access it quickly. Registers are the best place to hold data for quick access. Therefore, another trend is to design computer architectures with more registers rather than fewer registers. In the past, computer architectures may have had as few as eight registers, whereas today, computer architectures may have as many as 128 registers.

With the proliferation of price-sensitive, small yet powerful computing devices such as cell phones, beepers and computer operated appliances, there is a push to reduce the costs of producing these devices. One way of reducing costs is to reduce the amount of substrate used for producing processors in these devices. This may be accomplished by designing and producing processors with a reduced number of registers.

As a result of these trends, today's computer architectures for portable devices and computer operated appliances typically include a small number of registers while desktop computers, laptops, servers and other general purpose computers typically include a large number of registers. This presents a problem with the development of software. Generally, software written for a processor with a large number of registers will not run on a processor with a small number of registers. Furthermore, since the cost of software development has risen, cost savings may be accomplished by using software written for one computer architecture on machines having a different computer architecture.

### SUMMARY

According to an embodiment, a computer architecture is disclosed. The computer architecture includes a predetermined number of architected registers. The architected registers comprise a plurality of implemented registers and a plurality of unimplemented registers.

Another embodiment of a computer architecture includes a predetermined number of architected register means comprised of a first architected register means for storing data for a processor and a second architected register means in a memory for storing data for the processor. The computer architecture also includes a means for operating on data stored in one of the first architected registers means and the second architected register means.

According to an embodiment, a method for operating a processor having a predetermined number of architected registers is also disclosed. The architected registers include a plurality of implemented and unimplemented registers. The method includes a step of requesting a data operation on data located in one of the architected registers. A determination is then made as to whether the architected register is implemented or unimplemented. A data operation is then performed.

### BRIEF DESCRIPTION OF THE DRAWINGS

Embodiments are illustrated by way of example and without limitation in the accompanying figures in which like numeral references refer to like elements, and wherein:

FIG. 1 shows a block diagram of a computer architecture in accordance with an example;

FIG. 2 shows a block diagram of a computer architecture in accordance with another example;

FIG. 3 shows a block diagram of a computer architecture in accordance with yet another example;

FIGS. 4A and 4B show mapping tables of the register mapping logic of FIG. 3 in accordance with an example;

FIG. 5 shows a flow diagram of an operation mode of a computer architecture in accordance with an example; and

FIG. 6 shows a flow diagram of an operation mode of a computer architecture in accordance with another example.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

Throughout the present disclosure, reference is made to architected registers. Generally, a register is a high-speed memory used to store data and certain control information. The architected registers are necessitated by a computer processor's architecture and include a number of registers used by instructions written for the computer processor's architecture. That is, instructions may reference, for example, 16 registers. In that case, the architecture will include 16 architected registers that the instructions will reference. The architected registers store data and control information used by the instructions. A computer architecture may have any number of architected registers.

Reference is also made to a plurality of implemented registers. The implemented registers are those registers located in processor or central processing unit (hereinafter CPU). The implemented registers may be formed on the hardware of the processor or CPU as storage locations accessible by pieces of the processor through busses. The implemented registers may be accessed in a relative short period of time. However, they take up room on a substrate that may be used for other purposes.

Reference is also made to a plurality of unimplemented registers. The unimplemented registers perform the same function as implemented registers. However, the unimplemented registers are located in memory typically not in a processor or CPU. For example, random access memory (hereinafter RAM), cache memory, or hard drive memory may provide storage locations that function as unimplemented registers for the processor. Together, the implemented and unimplemented registers make up the number of architected registers necessitated by the computer processor's architecture.

In one example, a computer architecture includes a predetermined number of architected registers. The architected registers are composed of a plurality of implemented and unimplemented registers which together comprise the predetermined number of architected registers. The computer architecture is implemented in a computer system including a processor and memory accessible by the processor. The memory may be RAM or cache memory. The processor includes an arithmetic logic unit (hereinafter ALU), logic for accessing the implemented and unimplemented registers and the implemented registers. The memory includes storage locations for holding register data. These locations are the unimplemented registers.

This arrangement of implemented and unimplemented registers provides a significant cost savings when producing processors. The cost savings is twofold. Firstly, the amount of substrate required to produce a processor with a particular computer architecture may be reduced because some of the architected registers may be unimplemented. This reduces production costs. Secondly, the processor produced may run software written for a standardized computer architecture even though the processor has fewer implemented registers than necessitated by the standardized computer architecture. This reduces labor costs that would be involved in rewriting software to run on the processor.

Register miss routing logic may be used to access the implemented and unimplemented registers. The register miss routing logic accepts a request to access an architected register, implemented or unimplemented, and tries to access the implemented registers. If the register is implemented, the registered is accessed. That is, data is read from or written to the implemented register. If the register is unimplemented, the register miss routing logic then accesses the memory storage location holding data for one of the unimplemented registers which represents that particular architected register.

Instead of the register miss logic, register mapping logic may be used to access the implemented and unimplemented registers. The register mapping logic includes a mapping table for mapping architected registers to the implemented registers. The register mapping logic accepts a request to access an architected register and checks to see if that architected register is mapped to one of the implemented registers. If so, that implemented register is accessed. If the architected register is mapped to one of the unimplemented registers, data from one of the implemented registered is exchanged for data from the unimplemented register and the architected register is remapped to point to the implemented register. At this point, the implemented register is accessed.

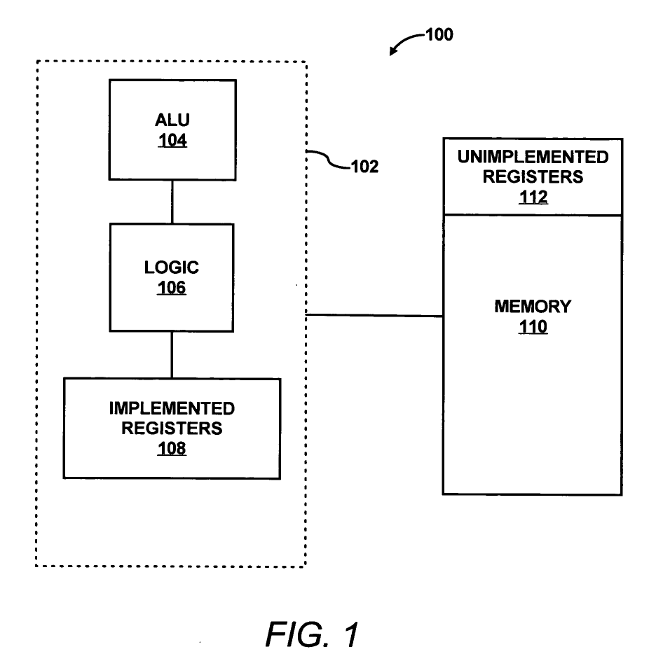

With reference first to FIG. 1, there is shown a block diagram of a computer architecture 100 in accordance with an example. The computer architecture 100 includes a CPU 102 having an ALU 104, logic 106 and a plurality of implemented registers 108. The CPU 102 is connected to memory 110. Some storage locations in the memory 110 function as a plurality of unimplemented registers 112.

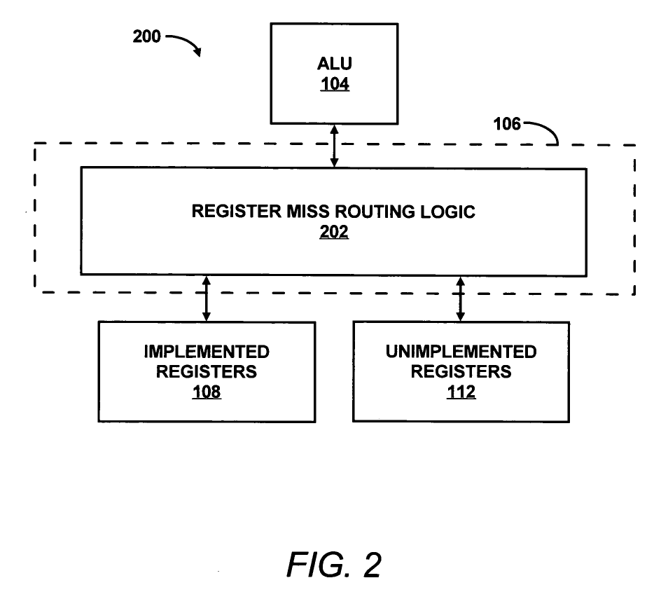

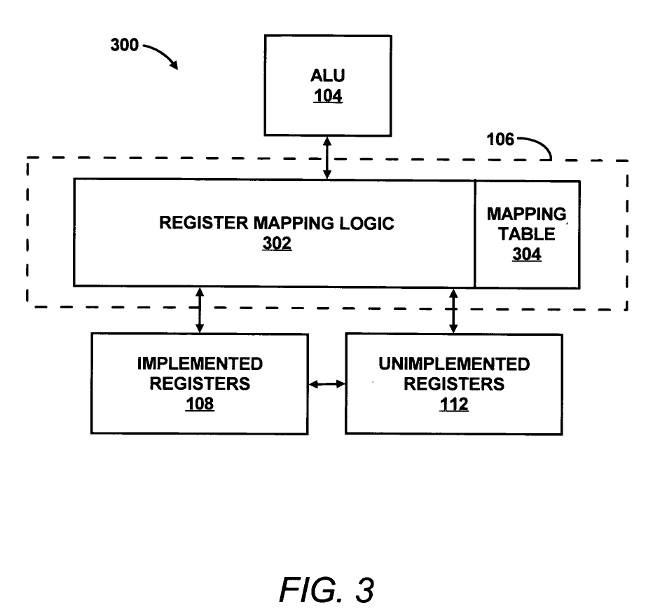

The computer architecture 100 includes a number of architected registers which are comprised of the plurality of implemented registers 108 in the CPU 102 in combination with the plurality of unimplemented registers 112 in the memory 110. The ALU 104 accesses the implemented and unimplemented registers 108 and 112 through the logic 106 which may be configured in a variety of manners such that the ALU 104 has access to both the implemented and unimplemented registers 108 and 112. Examples of the logic 106 is shown in FIGS. 2 and 3 and discussed in detail below.

Referring now to FIG. 2, there is shown block diagram of a computer architecture 200. The computer architecture 200 includes the ALU 104, the implemented registers 108, the unimplemented registers 112, and register miss routing logic 202. The register miss logic 202, which connects the ALU 104 to the implemented and unimplemented registers 108 and 112, is one example of the logic 106 shown in FIG. 1. This is illustrated by the dashed box 106 shown in FIG. 2. The register miss routing logic 202 accepts requests from the ALU 104 to access an architected register, that is, one of the implemented or unimplemented registers 108 or 112. Upon receiving a request to access one of the architected registers, the register miss routing logic 202 tries to access one of the implemented registers 108. If the access fails, the architected register does not exist in the implemented registers 108 and the register miss routing logic 202 then accesses one of the unimplemented registers 112 that stores data for the architected register. If the access succeeds, then the architected register exists in the implemented registers 108 and the register miss routing logic 202 accesses that implemented register which stores data for the architected register.

Referring now to FIG. 3, there is shown block diagram of the computer architecture 300 in accordance with another example. The computer architecture 300 includes the ALU 104, the implemented registers 108, the unimplemented registers 112, and register mapping logic 302, which is another example of the logic 106 shown in FIG. 1. This is illustrated by the dashed box 106 shown in FIG. 3. Register mapping logic 302 includes a mapping table 304 and connects the ALU 104 to the implemented and unimplemented registers 108 and 112. The register mapping logic 302 accepts requests from the ALU 104 to access an architected register, such as one of the implemented or unimplemented registers 108 or 112 which store data for the architected register. Upon receiving a request to access one of the architected registers, the register mapping logic 302 checks the mapping table 304 to determine if the architected register is currently implemented or unimplemented. If the architected register is implemented, the register mapping logic 302 accesses one of the implemented registers 108 that stores data for the architected register. If the architected register is unimplemented, the register mapping logic 302 moves data between one of the implemented registers 108 and one of the unimplemented registers 112 then updates the mapping table 304 so that the architected register maps to one of the implemented registers 108. The register mapping logic 302 then accesses one of the implemented registers 108 that stores data for the architected register.

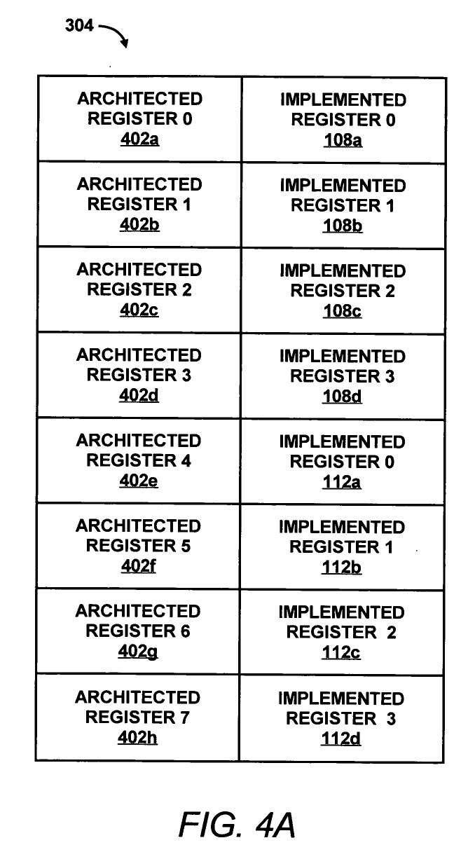

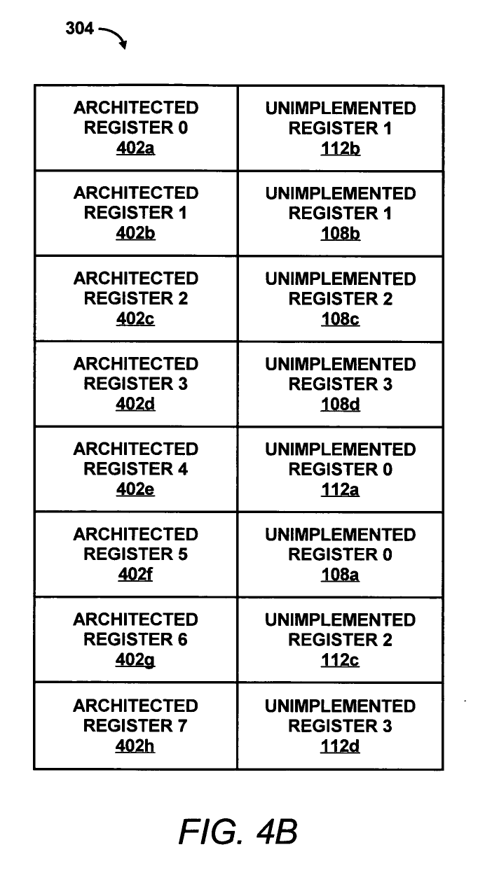

FIGS. 4A and 4B, collectively, show an example of the mapping table 304 including entries showing the relation between the architected registers and the implemented and unimplemented registers 108 and 112. In the example, there are eight architected registers 402a-402h. The first four architected registers 402a-402d map to the implemented registers 108a-108d. The last four architected registers 402e-402h map to the unimplemented registers 112a-112d. This arrangement is shown in FIG. 4A. If the ALU 104 requests access to the architected register 402a, the register mapping logic 302 accesses implemented register 108a that stores data for the architected register 404a. If the ALU 104 requests access to the architected register 402f, the register mapping logic 302 moves data between the unimplemented register 112b and the implemented register 108a. The register mapping logic 302 then updates the mapping table 304 so that the architected register 402f now maps to the implemented register 108a as shown in FIG. 4B. The register mapping logic 302 then accesses the implemented register 108a that stores data for the architected register 402f.

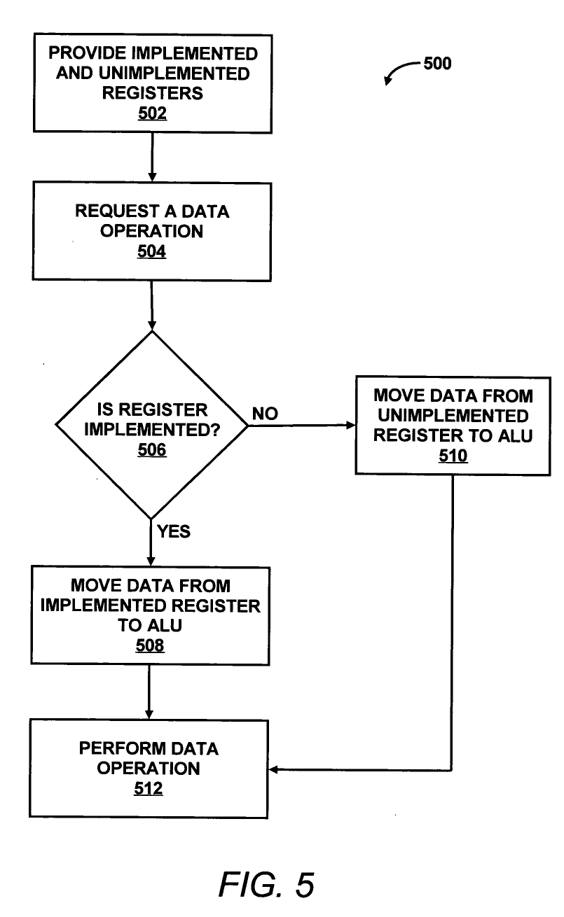

FIG. 5 shows a flow diagram of an example of an operation mode 500 of a computer architecture using register miss routing logic in accordance with an example. The following description of the operational mode 500 is made with reference to the computer architecture 200 illustrated in FIG. 2, and thus makes reference to the elements cited therein. The following description of the operational mode 500 is one manner in which the computer architecture 200 may be implemented. In this respect, it is to be understood that the following description of the operational mode 500 is but one manner of a variety of different manners in which such an architecture may be implemented.

In the operational mode 500, a number of architected registers are provided as a plurality of implemented and unimplemented registers 108 and 112 at step 502. The ALU 104 requests a data operation on one of the architected registers at step 504. The register miss routing logic 202 determines if the architected register is implemented at step 506 by trying to access one of the implemented registers 108. If the architected register is implemented, data is moved from the implemented register holding data for the architected register to the ALU at step 508. If the architected register is unimplemented, data is moved from the unimplemented register holding data for the architected register to the ALU 104 at step 510. The ALU 104 then performs the data operation at step 512.

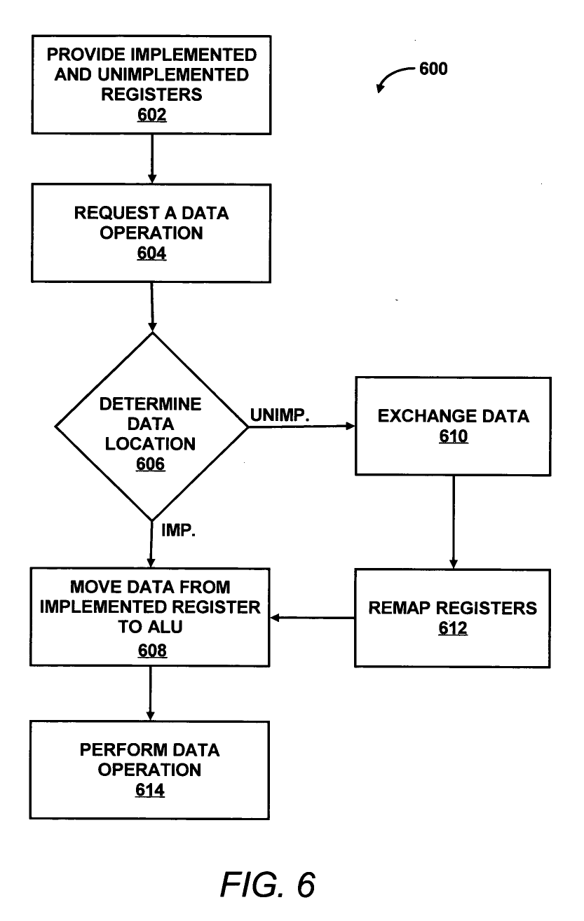

FIG. 6 shows a flow diagram of an example of an operation mode 600 of a computer architecture using register mapping logic in accordance with an example. The following description of the operational mode 600 is made with reference to the computer architecture 300 illustrated in FIG. 3, and thus makes reference to the elements cited therein. The following description of the operational mode 600 is one manner in which the computer architecture 300 may be implemented. In this respect, it is to be understood that the following description of the operational mode 600 is but one manner of a variety of different manners in which such an architecture may be implemented.

In the operational mode 600, a number of architected registers are provided as a plurality of implemented and unimplemented registers 108 and 112 at step 602. The ALU 104 requests a data operation on one of the architected registers at step 604. The register mapping logic 204 checks the mapping table 206 to determine if the architected register is implemented at step 606. If the architected register is implemented, data is moved from the implemented register holding data for the architected register to the ALU at step 608. If the architected register is unimplemented, data is exchanged between the unimplemented register holding data for the architected register and one of the implemented registers 108 at step 610. The mapping table 304 is updated so that the registers are remapped and the implemented register now holds data for the architected register in step 612. The ALU 104 then performs the data operation at step 612.

What has been described and illustrated herein are the embodiments. The terms, descriptions and figures used herein are set forth by way of illustration only and are not meant as limitations. Those skilled in the art will recognize that many variations are possible within the spirit and scope of the embodiments, which intended to be defined by the following claims and their equivalents in which all terms are meant in their broadest reasonable sense unless otherwise indicated.

1. A computer architecture having a predetermined number of architected registers, the computer architecture comprising:
a plurality of implemented registers; and
a plurality of unimplemented registers, wherein the plurality of implemented registers and the plurality of unimplemented registers comprises the predetermined number of architected registers.

2. The computer architecture of claim 1, wherein the plurality of unimplemented registers comprises storage locations in random access memory.

3. The computer architecture of claim 2, wherein the random access memory comprises cache memory.

4. The computer architecture of claim 3, further comprising dedicated cache memory for the plurality of unimplemented registers.

5. The computer architecture of claim 1, further comprising a register miss routing logic for reading data from one of the plurality of unimplemented registers.

6. The computer architecture of claim 1, further comprising a register mapping logic unit for moving data between one of the plurality of implemented registers and one of the plurality of unimplemented registers.

7. The computer architecture of claim 6, wherein the register mapping logic unit further includes a mapping table for mapping one of the predetermined number of architected registers to one of the plurality of implemented registers.

8. A method of operating a processor having a predetermined number of architected registers including a plurality of implemented and unimplemented registers, the method comprising the steps of:
requesting a data operation on data located in one of the predetermined number of architected registers;
determining whether the one of the predetermined number of architected registers is implemented or unimplemented; and
performing the data operation.

9. The method of claim 8, further comprising the step of moving the data from one of the plurality of implemented registers to an ALU in response to the one of the predetermined number of architected registers being implemented.

10. The method of claim 8, further comprising the steps of:
identifying an unimplemented register of the plurality of unimplemented registers storing the data in response to the one of the predetermined number of architected registers being unimplemented; and
swapping the data from the unimplemented register with data stored in one of the implemented registers.

11. The method of claim 10, further comprising the step of mapping the predetermined number of architected registers to the plurality of implemented registers and the plurality of unimplemented registers prior to performing the step of swapping.

12. The method of claim 11, further comprising the step of remapping the architected registers used in the swapping.

13. The method of claim 10, further comprising performing the data operation using the data stored in the implemented register after performing the step of swapping.

14. The method of claim 8, wherein the step of performing the data operation further comprises the step of moving data from one of the plurality of unimplemented registers to an ALU.

15. The method of claim 8, further comprising the step of designating a memory space for storing the plurality of unimplemented registers.

16. A computer architecture including a predetermined number of architected registers, the computer architecture comprising:
a first architected register means in a processor for storing data for the processor;
a second architected register means in a memory connected to the processor for storing data for the processor, wherein the predetermined number of architected registers comprises the first architected register means and the second architected register means; and
means for operating on data stored in one of the first architected registers means and the second architected register means.

17. The computer architecture of claim 16, further comprising:
means for determining whether to move data between the first architected register means and the second architected register means based on whether the means for operating on data is requesting data stored in the second architected register means; and
means for moving the requested data between the second architected register means and the first architected register means.

18. The computer architecture of claim 17, further comprising means for mapping the movement of data between the first and second architected register means.

19. The computer architecture of claim 16, further comprising register miss routing logic means for accessing data from the second architected register means.

20. The computer architecture of claim 16, wherein the second architected register means is located in a memory outside of the processor.
